(19) United States
(12) Patent Application Publication
(10) Pub. No.: US 2011/0104582 A1
(43) Pub. Date: May 5, 2011

(54) TAILORING LIQUID WATER PERMEABILITY OF DIFFUSION LAYERS IN FUEL CELL STACKS

(76) Inventors: Timothy W. Patterson, JR., West Hartford, CT (US); Gennady Resnick, Prospect Heights, IL (US); Ryan J. Balliet, Oakland, CA (US); Nikunj Gupta, Sugar Lake, TX (US); Cynthia A. York, Cookeville, TN (US); Carl A. Reiser, Stonington, CT (US); Robert M. Darling, South Windsor, CT (US); Jesse M. Marzullo, Meriden, CT (US); Jeremy P. Meyers, Austin, TX (US)

(21) Appl. No.: 12/734,636

(22) PCT Filed: Dec. 11, 2008
(86) PCT No.: PCT/US2008/013601

§ 371 Date: May 13, 2010

(51) Int. Cl. H01M 8/04; H01M 8/24

(52) U.S. Cl. 429/450

(57) ABSTRACT

A fuel cell stack (31) includes a plurality of fuel cells (9) each having an electrolyte such as a PEM (10), anode and cathode catalyst layers (13, 14), anode and cathode gas diffusion layers (16, 17), and water transport plates (21, 28) adjacent the gas diffusion layers. The cathode diffusion layer of cells near the cathode end (36) of the stack have a high water permeability, such as greater than 3×10⁻⁴ g/(Pa s m) at about 80° C. and about 1 atmosphere, whereas the cathode gas diffusion layer in cells near the anode end (35) have water vapor permeance greater than 3×10⁻⁴ g/(Pa s m) at about 80° C. and about 1 atmosphere. In one embodiment, the anode gas diffusion layer of cells near the anode end (35) of the stack have a higher liquid water permeability than the anode gas diffusion layer in cells near the cathode end; a second embodiment reverses that relationship.

### TECHNICAL FIELD

The liquid water permeability of the anode and cathode gas diffusion layers are tailored for each cell according to its position within the fuel cell stack, so as to promote movement of water toward water transport plates and away from catalysts, especially cathode catalysts, taking into account that water moves toward the cooler part of the stack during the cooling (and possibly freezing) process. By controlling the water movement of each cell during the cooling process, the cold start performance of the stack can be improved.

### BACKGROUND ART

It has been previously suggested that the startup procedure for a fuel cell stack at subfreezing temperature is hampered by the presence of ice in the porous catalyst layers of the electrodes. The ice prevents the reactant gases from reaching certain parts or even all of the electrodes' catalyst layer surfaces. To avoid such a situation, many proposals have been made for removing all of the water and water vapor from the stack when the stack is being shut down so that there is no possibility of ice being present upon re-establishing operation. Such systems are expensive, awkward, and quite time-consuming, and are certainly not at this time well suited for fuel cell power plants used in vehicles. The dry out of the cell stack assembly which is necessary for good cold start performance, can result in severe membrane stress, leading to untimely membrane failure.

Other approaches to the catalyst/ice problem include all sorts of heating methodologies, which are also expensive, cumbersome and require too much time, and are not well suited for vehicular applications.

### SUMMARY

Recognition of the fact that water in a fuel cell stack will tend to migrate toward the freezing front (toward the lower temperature along a temperature gradient), the liquid water permeability (water permeance) of gas diffusion layers (GDLs) is made lower than normal where a catalyst layer will be at a lower temperature than its corresponding water transport plate (WTP), and greater than normal where a catalyst layer will be at a higher temperature than its corresponding water transport plate. This gradation in GDL water permeance tailors the capability of the fuel cells to conduct water away from catalyst layers toward water transport plates, at either end of the stack, thus minimizing startup problems due to ice blockage of gas transport to the cells' catalyst layers.

Herein, the “anode end of the stack” and “anode end” are defined as the end of the stack at which the anode of the fuel cell closest to that end is closer to that end than the cathode of the closest fuel cell.

Specifically, at the anode end of the stack, each cells' anode water transport plate is closer to the stack end plate and therefore each WTP will be cooler than its associated anode catalyst layer, as the stack cools upon shutdown. As a result, during a shutdown procedure, water inventory normally tends to migrate through the anode gas diffusion layer (GDL) toward the water transport plate. Since this water migration is beneficial to fuel cell restart capability from a frozen condition, the GDL adjacent to each anode catalyst layer, at the anode end of the stack, has a greater than normal liquid permeability in order to promote water migration away from the anode catalyst layer.

On the other hand, at the anode end of the stack, the cathode catalyst layer is closer to the anode end plate and therefore colder than its associated cathode water transport plate. As a result, during a shutdown procedure, the fuel cell water inventory will normally migrate from the water transport plate (where it is abundant) toward the cathode catalyst layer. In order to impede this water flow, the cathode GDL is provided with lower than normal water liquid permeability.

When the stack temperature is below freezing, at the anode end of the stack, and freezing occurs in the small pores of the anode WTP, a decrease in the liquid pressure occurs drawing water out of the anode catalyst layer (toward the anode water transport plate) so that the anode catalyst layer dries out. On the other hand, as the water freezes in the small pores of the cathode catalyst layer, water is drawn out of the cathode water transport plate, through the cathode GDL and into the cathode catalyst layer. As the water is drawn into the cathode catalyst layer, the ice pressure increases, forcing small hydrophobic pores of the cathode catalyst layer, which are normally empty, to fill with ice. Once the pores of the cathode catalyst layer are filled, they are very difficult to empty. This cathode condition results in the performance loss seen after a boot strap start from freezing temperatures. While this phenomenon also works to fill the anode catalyst layer at the cathode end of the stack, the fuel cell is more tolerant of anode catalyst layer flooding due to rapid hydrogen/oxygen kinetics and hydrogen diffusion capability. Also, anode catalyst layer flooding is more easily recovered during normal fuel cell operation due to electro-osmotic drag of water from the anode electrode toward the cathode.

This water movement problem also exists in fuel cell power plants not utilizing water transport plates since there are small pores in the catalyst layers and water can move within the membrane electrode assembly itself. However, there is much less water inventory available to move within the cell (there is some liquid water in the GDLs and in the gas channels), so the problem is less severe.

The opposite situation occurs at the other end of the stack.

At the cathode end of the stack, the anode catalyst layer is closer to the cathode stack end plate and therefore cooler than its associated anode water transport plate as the stack cools upon shutdown. As a result, during a shutdown procedure, the fuel cell water inventory migrates from the water transport plate toward the anode catalyst layer. In order to impede this flow, the anode GDL at the cathode end of the stack is provided with lower than normal water permeability.

At the cathode end of the stack, the cathode water transport plate is closer to the cathode stack end plate, and therefore there is migration of water from the cathode catalyst towards the cathode water transport plate. To enhance this flow, the cathode GDL at the cathode end of the stack is provided with higher than normal permeability.

The arrangement herein may be utilized in several cells at each end of the stack, or up to one-half of the stack at each end of the stack if desired, but generally need not be utilized in every cell in the stack. For instance, applying the principles herein to 8 or 10 cells at either end of a stack will typically be sufficient to avoid ice blockage of reactant gases in the end cells. The arrangement may be used in fuel cell stacks with solid polymer electrolytes or liquid electrolytes. The arrangement may be used in power plants with external, internal, or some combination of water management systems, including evaporative cooling.

A second embodiment achieves a significant reduction in performance problems related to flooding electrode catalyst layers by taking advantage of the tolerance to flooding at the cell anodes referred to hereinbefore. In the second embodiment, the GDLs of cathodes and anodes at the anode end of the stack have lower than normal water permeability, while the GDLs of the cathodes and anodes at the cathode end of the stack have higher than normal water permeability.

A third embodiment also achieves a significant reduction in performance problems related to flooding of electrode catalyst layers by taking advantage of the tolerance to flooding at the cell anodes referred to hereinbefore. In the third embodiment, the GDLs of cathodes and anodes at the anode end of the stack have low water permeability, while at the cathode end of the stack, the GDLs of the cathodes have high water permeability and the GDLs of the anodes have low water permeability.

Other variations will become apparent in the light of the following detailed description of exemplary embodiments, as illustrated in the accompanying drawings.

### BRIEF DESCRIPTION OF THE DRAWINGS

FIG. 1 is a fractional, side elevation view of a pair of contiguous fuel cells of one exemplary form with which the present arrangement may be utilized.

FIG. 2 is a stylized, graphical depiction of a fuel cell stack and the GDL water permeability relationships in a first embodiment of the present arrangement relating to anodes and cathodes, at the anode end and at the cathode end of the stack.

FIG. 3 is a stylized, graphical depiction of a fuel cell stack and the GDL water permeability relationships in a second embodiment of the present arrangement relating to anodes and cathodes, at the anode end and at the cathode end of the stack.

FIG. 4 is a stylized, graphical depiction of a fuel cell stack and the GDL water permeability relationships in a third embodiment of the present arrangement relating to anodes and cathodes, at the anode end and at the cathode end of the stack.

### MODE(S) OF IMPLEMENTATION

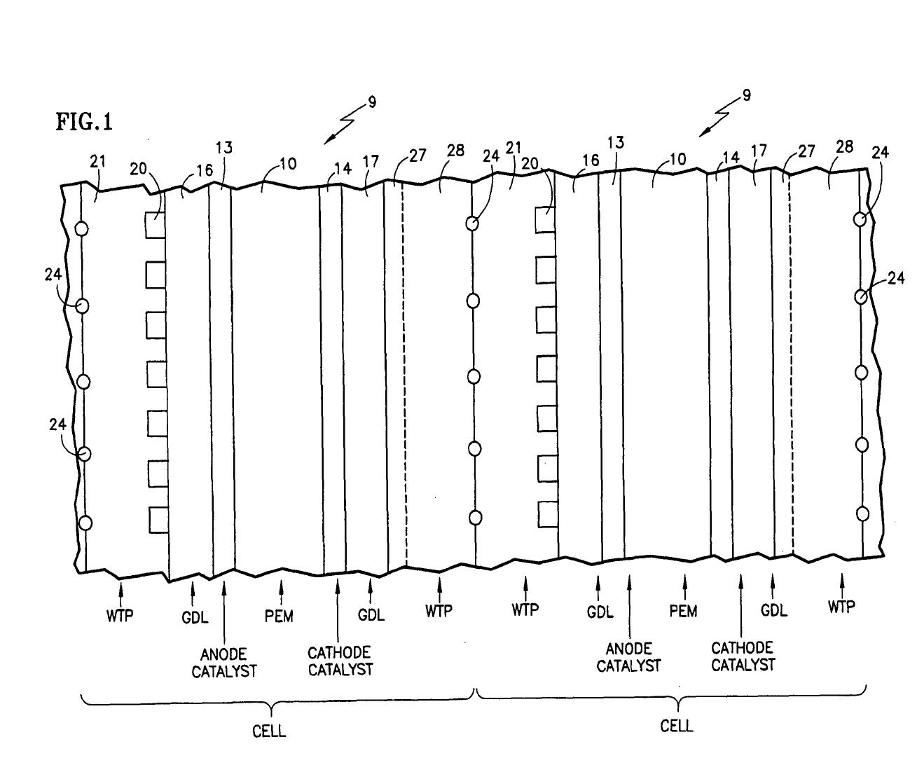

Referring to FIG. 1, a pair of fuel cells of one form with which the present arrangement may advantageously be utilized each include a proton exchange membrane 10 (PEM). On one surface of the PEM 10 there is an anode catalyst layer 13 and on the opposite surface of the PEM there is a cathode catalyst layer 14. Adjacent the anode catalyst layer there is a porous anode gas diffusion layer 16 (GDL), and adjacent the cathode catalyst layer there is a porous cathode GDL 17. Fuel is supplied to the anode in fuel reactant gas flow field channels 20 within an anode water transport plate 21 (WTP), which is sometimes referred to as a fuel reactant flow field plate. The water transport plate 21 is porous and at least somewhat hydrophilic to provide liquid communication between water channels, such as channels 24 (which may be formed in the opposite surface of the water transport plate from the fuel channels 20) and fuel channels 20.

Similarly, air is provided through oxidant reactant gas flow field channels 27 which are depicted herein as being orthogonal to the fuel channels 20. The air channels 27 are formed on one surface of the cathode water transport plates 28 which have characteristics similar to those of water transport plates 21.

The catalysts are conventional PEM-supported noble metal coatings typically mixed with a perfluorinated polymer, such as that sold under the tradename NAFION® which may or may not also contain teflon. The PEM 10 consists of a proton conductive material, typically perfluorinated polymer, such as that sold under the tradename NAFION®. Water is transferred from the water channels 24 through the porous, hydrophilic WTPs 21 and the anode GDL 16, to moisturize the PEM. At the catalyst layer, a reaction takes place in which two hydrogen diatomic molecules are converted catalytically to four positive hydrogen ions (protons) and four electrons. The protons migrate through the PEM to the cathode catalyst. The electrons flow through the fuel cell stack out of the electrical connections and through an external load, doing useful work. The electrons arriving at the cathode combine with two oxygen atoms and the four hydrogen ions to form two molecules of water. The reaction at the anode requires the infusion of water to the anode catalyst, while the reaction at the cathode requires the removal of product water which results from the electrochemical process as well as water dragged through the PEM from the anode by moving protons (and osmosis).

The cathode catalyst layer 14 is similarly porous and the GDL 17 is porous to permit air from the channels 27 to reach the cathode catalyst and to allow product and proton drag water to migrate to the cathode WTP, where the water will eventually reach the water channels 24. In a power plant having an external water management system, the water will exit the stack for possible cooling, storage and return to the stack as needed.

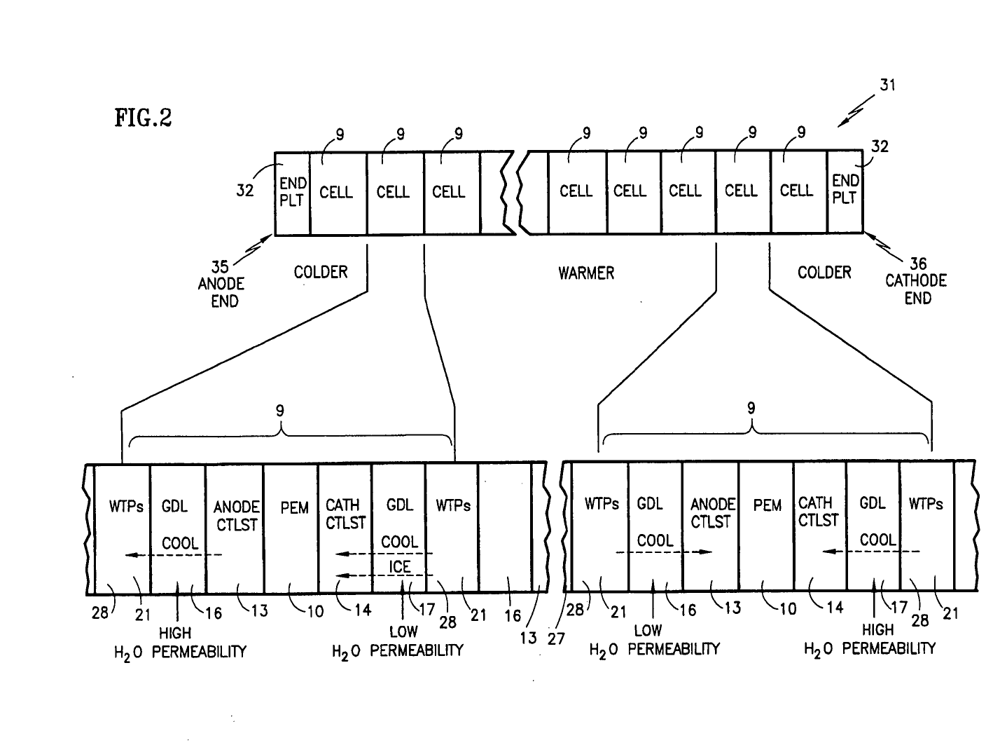

Referring to FIG. 2, a fuel cell stack 31 is depicted at the top with a plurality of contiguous fuel cells 9 pressed together between end plates 32. There is an anode stack end 35 and a cathode stack end 36. The fuel cells typically operate at temperatures above 60° C. (140° F.) in environments which are typically 37° C. (100° F.) or lower. In some cases, the environment may be below the freezing temperature of water. Whenever the fuel cell is shut down, the ends of the fuel cell cool down more quickly than the center of the fuel cell, particularly where the stack is surrounded either by external reactant gas manifolds or insulation. Thus, each cell that is not at the end of the stack is somewhat warmer than an adjacent cell which is closer to the end of the stack. Thus, there is an increasing temperature gradient from the ends of the stack toward the center of the stack, with the stack becoming warmer towards the center cells. This temperature gradient also exists between the different parts of each fuel cell near the ends of the stack, as indicated in FIG. 2. Along the lower part of FIG. 2, the light dashed arrows indicate water migrating as a function of temperature gradient, and the darker dashed arrow indicates migration resulting from ice, as described hereinbefore.

Along the bottom of FIGS. 2-4, the various GDLs are identified as desirably having higher than normal liquid water permeability or low liquid water permeability, according to the foregoing descriptions.

Variations in liquid water permeability may be achieved by adjusting the characteristics of the paper of which the GDL is formed, which is typically a mixture of fiber and particulate carbon, such as one of the readily available TORAY® papers, having suitable porosity and pore size for proper passage of reactant gas. The degree of hydrophobicity is then adjusted by adding an appropriate thin coating of a suitable polymer, such as PTFE. On the other hand, the paper can be produced with a desired hydrophobicity by including a suitable thermoplastic resin in the paper making process.

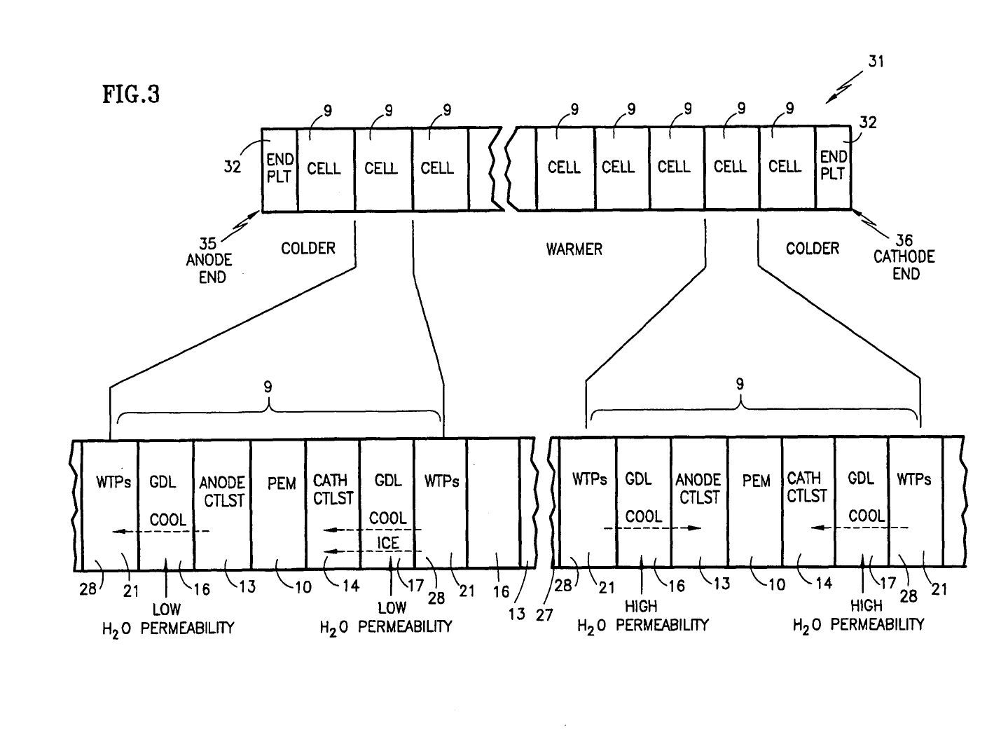

In the embodiment of FIG. 3, the water permeability of the anode GDLs at both ends of the stack supports water migration toward the anode catalysts, relying on the ability of anodes to clear water away and to recover performance. However, the water permeability of the cathode GDLs at both ends of the stack resists water migration toward the cathode catalysts.

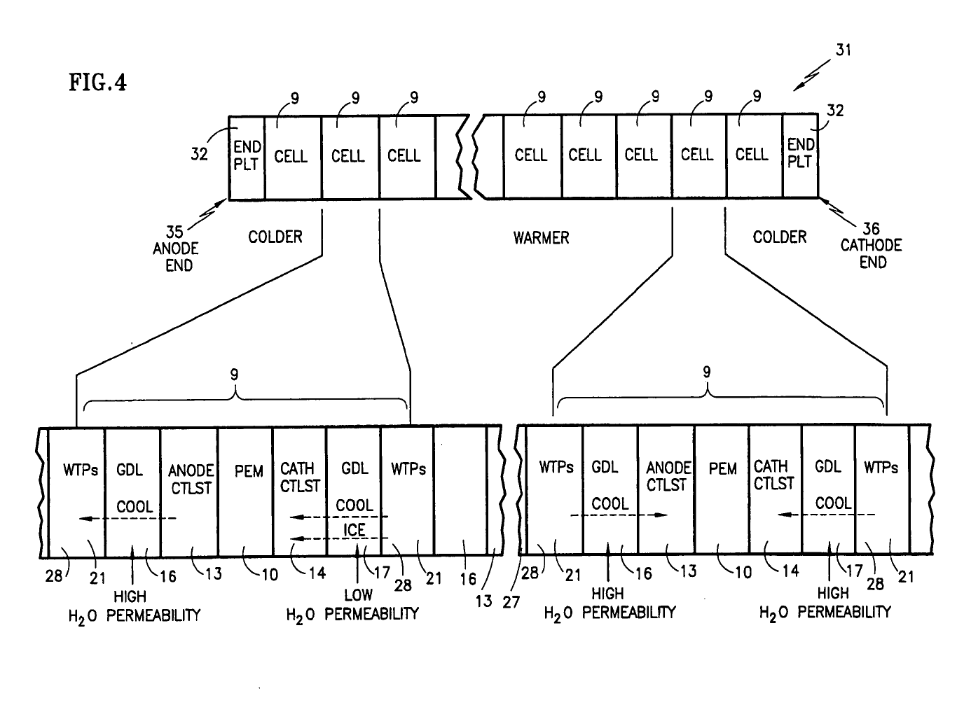

The embodiment of FIG. 4 takes advantage of the tolerance to flooding at the cell anodes. In FIG. 4, the GDLs of cathodes and anodes at the anode end of the stack have low water permeability, while at the cathode end of the stack, the GDLs of the cathodes have high water permeability and the GDLs of the anodes have low water permeability.

As used herein, the gas diffusion layer is defined as being one or more layers interposed between an electrode and a water transport plate. It is sometimes called a support layer. Sometimes a support layer is referred to as having a substrate which is adjacent to the water transport plate as well as a microporous layer that is adjacent to the catalyst. Typically, the substrate will be relatively hydrophilic whereas the adjacent microporous layer will be relatively hydrophobic. Thus, a support comprising a substrate and a microporous layer will be referred to herein as a gas diffusion layer (GDL). On the other hand, a gas diffusion layer may only comprise what is essentially the same as a substrate layer of a two-layer gas diffusion layer. In this arrangement, the gas diffusion layer can be a single layer or it can be a dual layer or even have more than two layers.

The thickness, or porosity or wettability of the support layer may be adjusted in any combination to provide a greater or lesser impediment to the migration of water. However, the control of water permeability may also be imparted by the characteristics, particularly pore size and hydrophobicity, of the microporous diffusion layer, rather than the support.

The adjustments between high liquid water permeability GDLs and low liquid water permeability GDLs may, in some cases, be made on a relative basis, that is to say, having the anode end, cathode GDLs and the cathode end, anode GDLs with a water permeability which is some percentage of the water permeability of the anode end, anode GDL and the cathode end, cathode GDL. But generally, the absolute liquid water permeability of each GDL (or groups of GDLs) will be selected without regard to the liquid water permeability of other GDLs of the stack subject to other, different operational characteristics. Low liquid water permeability may range from near zero up to about 3×10⁻⁴ g/(Pa s m) and high liquid water permeability may exceed normal, which is about 3×10⁻⁴ g/(Pa s m).

Herein, the anode water transport plate 21 is illustrated as being separated from the cathode water transport plate 28, meeting at a seam which together form water passageways 24. However, it is possible that the water transport plates 21, 28 may be combined in some fashion without altering the advantage of the present arrangement.

1. Apparatus comprising:
a fuel cell stack (31) including a plurality of contiguous fuel cells (9) compressed between a pair of end plates (32), each of said fuel cells comprising an electrolyte (10) with an anode catalyst layer (13) on one surface of the electrolyte and a cathode catalyst layer (14) on a second surface of the electrolyte, an anode gas diffusion layer (16) adjacent the anode catalyst and a cathode gas diffusion layer (17) adjacent the cathode catalyst, an anode water transport plate (21) adjacent the anode gas diffusion layer and a cathode water transport plate (28) adjacent the cathode gas diffusion layer;
said stack having an anode end (35) and a cathode end (36);
characterized by:
the cathode gas diffusion layer of cells near the cathode end having higher water permeability than the cathode gas diffusion layer of cells near the anode end.

2. Apparatus according to claim 1 further characterized in that:
the cathode gas diffusion layer (17) of cells near the cathode end (36) have water permeability greater than about 3×10⁻⁴ g/(Pa s m) at about 80° C. and about 1 atmosphere.

3. Apparatus according to claim 1 further characterized in that:
the water permeability of the cathode gas diffusion layer (17) of cells near the anode end (35) is lower than 3×10⁻⁴ g/(Pa s m) at about 80° C. and about 1 atmosphere.

4. Apparatus comprising:
a fuel cell stack (31) including a plurality of contiguous fuel cells (9) compressed between a pair of end plates (32), each of said fuel cells comprising an electrolyte (10) with an anode catalyst layer (13) on one surface of the electrolyte and a cathode catalyst layer (14) on a second surface of the electrolyte, an anode gas diffusion layer (16) adjacent the anode catalyst and a cathode gas diffusion layer (17) adjacent the cathode catalyst, an anode water transport plate (21) adjacent the anode gas diffusion layer and a cathode water transport plate (28) adjacent the cathode gas diffusion layer;
said stack having an anode end (35) and a cathode end (36);
characterized by:
the anode and cathode gas diffusion layers (16, 17) of cells near the anode end (35) having water permeability which is lower than the water permeability of the anode and cathode gas diffusion layers of cells near the cathode end (36).

5. Apparatus according to claim 4 further characterized in that:
the anode gas diffusion layer (16) of cells near the anode end (35) having water permeability greater than about 3×10⁻⁴ g/(Pa s m) at about 80° C. and about 1 atmosphere.

6. Apparatus according to claim 4 further characterized in that:
the water permeability of the anode gas diffusion layer (16) of cells near the cathode end (36) is less than about 3×10⁻⁴ g/(Pa s m) at about 80° C. and about 1 atmosphere.

7. Apparatus according to claim 1 further characterized by:
the anode gas diffusion layer (16) of cells near the anode end (35) having water permeability which is less than the water permeability of the anode gas diffusion layer (16) of cells near the cathode end (36).

8. Apparatus according to claim 1 further characterized by:
the anode gas diffusion layer (16) of cells near the anode end (35) having water permeability which is equal to the water permeability of the anode gas diffusion layer (16) of cells near the cathode end (36).

9. Apparatus according to claim 8 further characterized in that:
the water permeability of the anode gas diffusion layer (16) of cells near the cathode end (36) and the anode gas diffusion layer (16) of cells near the anode end (35) is greater than about 3×10⁻⁴ g/(Pa s m) at about 80° C. and about 1 atmosphere.

10. Apparatus comprising:
a fuel cell stack (31) including a plurality of contiguous fuel cells (9) compressed between a pair of end plates (32), each of said fuel cells comprising an electrolyte (10) with an anode catalyst layer (13) on one surface of the electrolyte and a cathode catalyst layer (14) on a second surface of the electrolyte, an anode gas diffusion layer (16) adjacent the anode catalyst and a cathode gas diffusion layer (17) adjacent the cathode catalyst, an anode water transport plate (21) adjacent the anode gas diffusion layer and a cathode water transport plate (28) adjacent the cathode gas diffusion layer;
said stack having an anode end (35) and a cathode end (36);
characterized by:
the anode gas diffusion layer (16) of cells near the anode end (35) having water permeability which is less than the water permeability of the anode gas diffusion layer (16) of cells near the cathode end (36).

11. Apparatus according to claim 9 further characterized in that:
the anode gas diffusion layer (16) of cells near the anode end (35) have liquid water permeability less than about 3×10⁻⁴ g/(Pa s m) at about 80° C. and about 1 atmosphere.

12. Apparatus according to claim 9 further characterized in that:
the water vapor permeability of the anode gas diffusion layer (16) of cells near the cathode end (36) is greater than about 3×10⁻⁴ g/(Pa s m) at about 80° C. and about 1 atmosphere.

13. Apparatus according to claim 10 further characterized by:
the cathode gas diffusion layer of cells near the cathode end having higher water permeability than the cathode gas diffusion layer of cells near the anode end.
